(19) United States
(12) Patent Application Publication
(10) Pub. No.: US 2017/0026311 A1
(43) Pub. Date: Jan. 26, 2017

(54) METHOD AND SYSTEM FOR ALLOCATING VIDEO TRANSCODING RESOURCES

(71) Applicants: LE HOLDINGS (BEIJING) CO., LTD., Beijing (CN); LE CLOUD COMPUTING CO., LTD., Beijing (CN)

(72) Inventors: Xiaoqing WANG, Beijing (CN); Dalei BAO, Beijing (CN)

(21) Appl. No.: 15/219,768

(22) Filed: Jul. 26, 2016

Related U.S. Application Data
(63) Continuation of application No. PCT/CN2016/082909, filed on May 20, 2016.

(30) Foreign Application Priority Data
Jul. 24, 2015 (CN) 201510440991.X

(51) Int. Cl. H04L 12/927; G06F 9/50; H04N 19/40; H04L 12/911; H04L 29/08; H04L 29/06

(52) U.S. Cl. CPC H04L 47/801; H04L 67/10; H04L 65/605; H04N 19/40; H04L 47/826; G06F 9/5027

(57) ABSTRACT

Embodiments of this disclosure provide a method and system for allocating transcoding resources so as to address the problem in the prior art of underutilizing transcoding resources so that if there are a large number of videos to be transcoded, the efficiency of transcoding may be seriously reduced. In an embodiment of this disclosure, a resource value to be consumed for transcoding a video corresponding to a transcoding task is determined; and transcoding resources are allocated for the transcoding task from currently allocable transcoding resources upon judging that transcoding resources can be allocated for the transcoding task, according to the transcoding resource value corresponding to the transcoding task, and a condition of occupied transcoding resources, instead of configuring a fixed workload of transcoding, thus improving utilization ratio of the resources so that if there are a number of videos to be transcoded, the efficiency of transcoding will be improved.

This application is a continuation of International Application No. PCT/CN2016/082909, filed on May 20, 2016, which is based upon and claims priority to Chinese Patent Application No. 201510440991.X, filed on Jul. 24, 2015, both of which are incorporated herein by reference in their entireties.

### FIELD

Embodiments of this disclosure relate to the field of videos, and particularly to a method and system for allocating video transcoding resources.

### BACKGROUND

A cloud service refers to a mode in which a service in question is offered, accessed, and delivered over the Internet, and typically invokes dynamically extensible and frequently virtualized resources provided over the Internet. The cloud service enables the desirable service to he available over the Internet in an on-demand and extensible manner, where the desirable service can be IT, software and Internet-related, or another service.

Video transcoding is the most important stage in producing a video. Video transcoding refers to conversion of a compressed and encoded video code stream into another video code stream adapted to a varying network bandwidth, a varying terminal processing capability, and a different user demand. Transcoding essentially refers to a process of firstly decoding and then encoding the video.

As cloud computing is being developed rapidly, a cloud transcoding service has become increasingly improved. The existing cloud transcoding service configures each transcoding server with a fixed workload so that the transcoding server executes each transcoding task according to the fixed workload, and stops the transcoding task from being executed, if the fixed workload is reached.

As there are a growing number of users of cloud computing, there will be a huge number of video transcoding requests to the cloud transcoding service. If each transcoding server is configured with a fixed workload of transcoding as in the prior art, then the resources may be underutilized, so that if there are a large number of videos to be transcoded, then the efficiency of transcoding may be seriously reduced.

In summary, the resources may be underutilized while transcoding as in the prior art so that if there are a large number of videos to be transcoded, then the efficiency of transcoding may be seriously reduced.

### SUMMARY

Embodiments of this disclosure provide a method and system for allocating video transcoding resources so as to address the problem in the prior art of underutilizing the transcoding resources so that if there are a large number of videos to be transcoded, then the efficiency of transcoding may be seriously reduced.

Some embodiments of this discourse provides a method for allocating video transcoding resources, the method includes:

generating a transcoding task in response to a received transcoding request;
determining a transcoding resource value corresponding to the transcoding task, wherein the transcoding resource value corresponding to the transcoding task represents the number of resources of a transcoding server consumed for processing a video corresponding to the transcoding task;
judging whether transcoding resources can be allocated for the transcoding task, according to the transcoding resource value corresponding to the transcoding task, and a condition of occupied transcoding resources;
allocating transcoding resources for the transcoding task from currently allocable transcoding resources upon judging that transcoding resources can be allocated for the transcoding task.

Some embodiments of this discourse provides a system for allocating video transcoding resources, the system includes at least one processor and a memory commumcably connected with the at least one processor for storing instructions executable by the at least one processor, wherein execution of the instructions by the at least one processor causes the at least one processor to:

generate a transcoding task in response to a received transcoding request;
determine a transcoding resource value corresponding to the transcoding task, wherein the transcoding resource value corresponding to the transcoding task represents the number of resources of a transcoding server consumed for processing a video corresponding to the transcoding task;
judge whether transcoding resources can be allocated for the transcoding task, according to the transcoding resource value corresponding to the transcoding task, and a condition of occupied transcoding resources;
allocate transcoding resources for the transcoding task from currently allocable transcoding resources after the judging unit judges that transcoding resources can be allocated for the transcoding task.

In the embodiments of this disclosure, a resource value to be consumed for transcoding a video corresponding to a transcoding task is determined: and transcoding resources are allocated for the transcoding task from currently allocable transcoding resources upon judging that transcoding resources can be allocated for the transcoding task, according to the transcoding resource value corresponding to the transcoding task, and a condition of occupied transcoding resources, instead of configuring a fixed workload of transcoding as in the prior art, thus improving the utilization ratio of the resources so that if there are a number of videos to be transcoded, then the efficiency of transcoding will be improved.

### BRIEF DESCRIPTION OF THE DRAWINGS

In order to make the technical solutions according to the embodiments of this disclosure or in the prior art more apparent, the drawings to which a description of the embodiments or the prior art refers will be briefly introduced below, and apparently the drawings 10 be described below are merely illustrative of some of the embodiments of the disclosure, and those ordinarily skilled in the art can derive from these drawings other drawings without any inventive effort, wherein elements having the same reference numeral designations represent like elements throughout. The drawings are not to scale, unless otherwise disclosed. In the drawings:

FIG. 1 is a schematic flow chart of a method for allocating video transcoding resources according to an embodiment of this disclosure;

FIG. 2 is a schematic diagram of a pool of transcoding resources according to an embodiment of this disclosure:

FIG. 3 is a schematic diagram of a queue of resource requests according to an embodiment of tins disclosure;

FIG. 4 is a schematic diagram of idle resources according to an embodiment of this disclosure;

FIG. 5 is a schematic structural diagram of allocating video transcoding resources according to an embodiment of tins disclosure,

FIG. 6 is a schematic structural diagram of a system for allocating video transcoding resources according to an embodiment of this disclosure; and

FIG. 7 is a schematic flow chart of an application of a method for allocating video transcoding resources according to an embodiment of this disclosure.

### DETAILED DESCRIPTION OF THE EMBODIMENT

In order to make the objects, technical solutions, and advantages of the embodiments of this disclosure more apparent, the technical solutions according to the embodiments of this disclosure will be described below clearly and fully with reference to the drawings in the embodiments of this disclosure, and apparently the embodiments described below are only a part hut not all of Ac embodiments of this disclosure. Based upon the embodiments here of the invention, all the other embodiments which can occur to those skilled in the art without any inventive effort shall fall into the scope of the invention.

In the embodiments of this disclosure, a resource value to be consumed for transcoding a video corresponding to a transcoding task is determined; and transcoding resources are allocated for the transcoding task from currently allocable transcoding resources upon judging that transcoding resources can be allocated for the transcoding task, according to the transcoding resource value corresponding to the transcoding task, and a condition of occupied transcoding resources, instead of configuring a fixed workload of transcoding as in the prior art, thus improving the utilization ratio of the resources so that if there are a number of videos to be transcoded, then the efficiency of transcoding will be improved.

The embodiments of this disclosure will be described below in further details with reference to the drawings.

As illustrated in FIG. 1, a method for allocating transcoding resources according to an embodiment of this disclosure includes the following steps:

The step 101 is to generate a transcoding task in response to a received transcoding request;

The step 102 is to determine a transcoding resource value corresponding to the transcoding task, where the transcoding resource value corresponding to the transcoding task represents the number of resources of the transcoding server consumed for processing a video corresponding to the transcoding task;

The step 103 is to judge whether transcoding resources can be allocated for the transcoding task, according to the transcoding resource value corresponding to the transcoding task, and a condition of occupied transcoding resources; and

The step 104 is to allocate transcoding resources for the transcoding task from currently allocable transcoding resources upon judging that transcoding resources can be allocated for the transcoding task.

In an embodiment of this disclosure, if there is a demand for transcoding the video, then a video transcoding request can be transmitted.

For example, if a user needs to transcode the video, then the user can transmit the video transcoding request through a service end.

The service end in an embodiment of this disclosure can be a service end operating in a mobile terminal, or can be an application end operating in a computer; or can be a service end operating in another device; or can be a remote server.

Since there may be a large number of video transcoding requests received in a period of time, optionally the video transcoding requests can be put into a queue of tasks upon reception of the video transcoding requests, and then the tasks in the queue of tasks can be executed sequentially in their order in the queue of tasks.

The video transcoding requests can be put into the queue of tasks in a number of ways, for example, the video transcoding requests can be put into the queue of tasks in an order of the times when the video transcoding requests are received; or the video transcoding requests can be put into the queue of tasks in an order of the priorities of the video transcoding requests.

If the video transcoding requests are put into the queue of tasks in an order of the times when the video transcoding requests are received, then a newly received video transcoding request can be put at the end of the queue of tasks upon reception of the new video transcoding request.

If the video transcoding requests are put into the queue of tasks in an order of the priorities of the video transcoding requests, then the video transcoding requests with higher priorities can be put before the video transcoding requests with lower priorities.

Optionally the priorities of the video transcoding requests can be preset on demand, for example, the priorities of the video transcoding requests can be determined by video formats into which the video transcoding requests need to be transcoded; or the priorities of the video transcoding requests can be determined by users transmitting the video transcoding requests.

If the priorities of the video transcoding requests are determined by the video formats into which the video transcoding requests need to be transcoded, then optionally the priorities of the video transcoding requests to be transcoded into lower-definition video formats will be higher.

If the priorities of the video transcoding requests are determined by the users transmitting the video transcoding requests, then optionally the priorities of the video transcoding requests transmitted by advanced users will be higher.

The video transcoding request can be processed by generating the transcoding task from the video transcoding request.

Optionally the transcoding task is generated according to a target definition of transcoding in the video transcoding request, for example, if there are three different target definitions of transcoding in the video transcoding request, then three different transcoding tasks will be generated, where these transcoding tasks include transcoding parameters, logo demands, video source addresses, and other information, and these three transcoding tasks will be put into the queue of tasks.

After the transcoding task is generated, the transcoding resource value corresponding to the transcoding task will be determined, where the transcoding resource value corresponding to die transcoding task is a resource value to be consumed for transcoding the video corresponding to the transcoding task.

In an embodiment of this disclosure, a transcoding resource consumption evaluating system is introduced. The transcoding resource consumption evaluating system in the embodiment of this disclosure includes the transcoding resource value corresponding to the transcoding task, and the condition of occupied transcoding resources (the condition of occupied transcoding resource resources will be described later).

For the transcoding resource value corresponding to the transcoding task, the different transcoding tasks relate to different sizes and formats of video sources, and different target output definitions, so the transcoding tasks may consume significantly different transcoding resources.

In an embodiment of this disclosure, a transcoding server of which the elementary number of resources of is 100, acts to a carrier to estimate the numbers of resources to be consumed for the different transcoding tasks to thereby calculate the theoretical numbers of resources to be consumed for transcoding the videos into the respective levels of definitions.

Here the elementary number of resources is merely exemplified as 100, but can be another value as needed.

Optionally the transcoding resource value corresponding to the transcoding task can be determined by determining the transcoding resource value corresponding to the transcoding task according to a correspondence relationship between video formats and transcoding resource values.

The correspondence relationship between video formats and transcoding resource values can be preset empirically, on demand, etc. An example of the correspondence relationship between video formats and transcoding resource values will be given below as depicted in the table below:

| | Theoretical resource |
|---|---|
| | consumption value |
| | (transcoding resource value |
| Output definition | corresponding to transcoding task) |
| MP4 | 5 |
| MP4_350 | 8 |
| MP4_800 | 10 |
| MP4_1300 | 12 |
| MP4_720P | 15 |
| MP4_1080P | 20 |
| MP4_4K | 40 |

The estimated values in the table are theoretical estimated values without degrading the efficiency of transcoding, and a throughout capacity, and the theoretical estimated values can be further learned and revised constantly using constantly generated real data while the video is being transcoded in reality, so that the theoretical estimated values can increasingly approximate a correct interval of estimation values.

In an embodiment of this disclosure, all the production data are collected and processed by a way of big data acquisition in a routine transcoding process, and after the data are obtained, real resource consumption values of transcoding tasks at respective levels of definitions are calculated from the data according to the distribution of the respective definitions in the real production data.

Particularly the transcoding server executing the transcoding tasks is sampled to obtain resource information of the transcoding server, and video format-speed ratio of the currently transcoding resources, where the video format-speed ratio refers to the ratio of the length of time taken to transcode into the video format to the length of time for the corresponding resource;

Transcoding resource values of the different video formats are determined according to the resource information of the transcoding server, and the video format-speed ratio of the currently transcoding resources, which are obtained as a result of sampling for a number of times;

The average transcoding resource value of the same video format is determined by averaging transcoding resource values of the same video format; and

The transcoding resource value corresponding to the video format in the correspondence relationship is updated using the average transcoding resource value of the same video format.

Optionally the transcoding resource value of the video format is determined in the equation of:

A₁×C₁×R₁+A₂×C₂×R₂+ . . . Aₙ×Cₙ×Rₙ=Y_{z}

Where Rn represents a transcoding resource value of a video format n; Aₙ represents a video format speed ratio of the video format n; Cₙ represents the number of parallel task of the transcoding server Z being sampled; and Y_{z}=M_{z}*P_{z}, where Y_{z} represents the resource information of the transcoding server Z, M_{z} represents a resource score of the transcoding server Z, and P_{z} represents the occupancy ratio of resources of the transcoding server Z being sampled.

In an implementation, the video format speed ratio can be calculated by weight-averaging video format-speed ratio of a number of tasks as a stable value over a long period of time.

For example, if a transcoding task needs to convert a resource A into the mp4_640 format, a period of time taken to transcode the resource A into the mp4_640 format is determined as T1, and a length of time taken to play a section thereof to be transcoded is determined as T2 (for example, if contents of the resource A from the 60^{th} minute to the 120^{th} minute needs to be transcoded, then T1 will represent a period of time taken to transcode die contents of the resource A from the 60^{th} minute to the 120^{th} minute, and T2 will represent a length of time taken to play the section to be transcoded, i.e., a length of time from the 60^{th} minute to the 120^{th} minute, which is 60 minutes here), then T2/T1 will be calculated as a video format speed ratio of the mp4_640 format, and a number of video format-speed ratio of the mp4_640 format will be weight-averaged as a resulting video format speed ratio of the mp4_640 format.

Subsequently calculated new video format-speed ratio of the mp4_640 format are constantly added to and weight-summed with the last resulting video format-speed ratio, thus resulting in a stable value over a long period of time.

The resource score of the transcoding server Z is a reference score calculated by-testing periodically the performance of a machine.

An example will be given below:

| Type Task | Speed ratio |
|---|---|
| A1 (mp4_640) | 1 |
| A2 (mp4_800) | 0.5 |
| A3 (mp4_1300) | 0.3 |

Since there are a number of values of R to be determined in the equation above, a set of equations can be created by testing on different types of tasks which are combinated, to thereby solve for the different values of R:

1*R1*8+0.5*R2*10=100*0.99

0.5*R2*10+0.3*R3*5−90*0.87

0.5*R1*4+0.3*R3*8−85*1

. . .

N sets of R1, M sets of R2, and N sets of R3 can be calculated from N sets of sample data.

Then the sets of R1 determined by sampling over a period of time are weight-averaged, thus resulting in the average thereof over the period of time, and an average over a unit of time is calculated from a number of average data to thereby modifying the transcoding resource value corresponding to mp4_640.

Alike the same process can be performed on R2 and R3, so a repeated description will be omitted here.

Here taking a month (or a season or a year or more) of data as a unit of time, for example, the theoretical estimated values in the table above can be revised using the real resource consumption values, where the theoretical estimated values are revised constantly by constantly generating a large number of data samples throughout transcoding, and calculating their weight-averages, so that the theoretical values unlimitedly approximate the real consumption values.

It shall be noted that the embodiment of this disclosure will not be limited to the approach above in which the transcoding resource value corresponding to the transcoding task is determined, but any other approaches in which the transcoding resource value corresponding to the transcoding task is determined will be applicable to the embodiment of this disclosure.

In the embodiment of this disclosure, the video is transcoded by the transcoding server, and since there are a large number of widely distributed transcoding servers, the transcoding servers are grouped into a number of pools of transcoding resource in an embodiment of this disclosure to thereby manage and search for the transcoding resources conveniently.

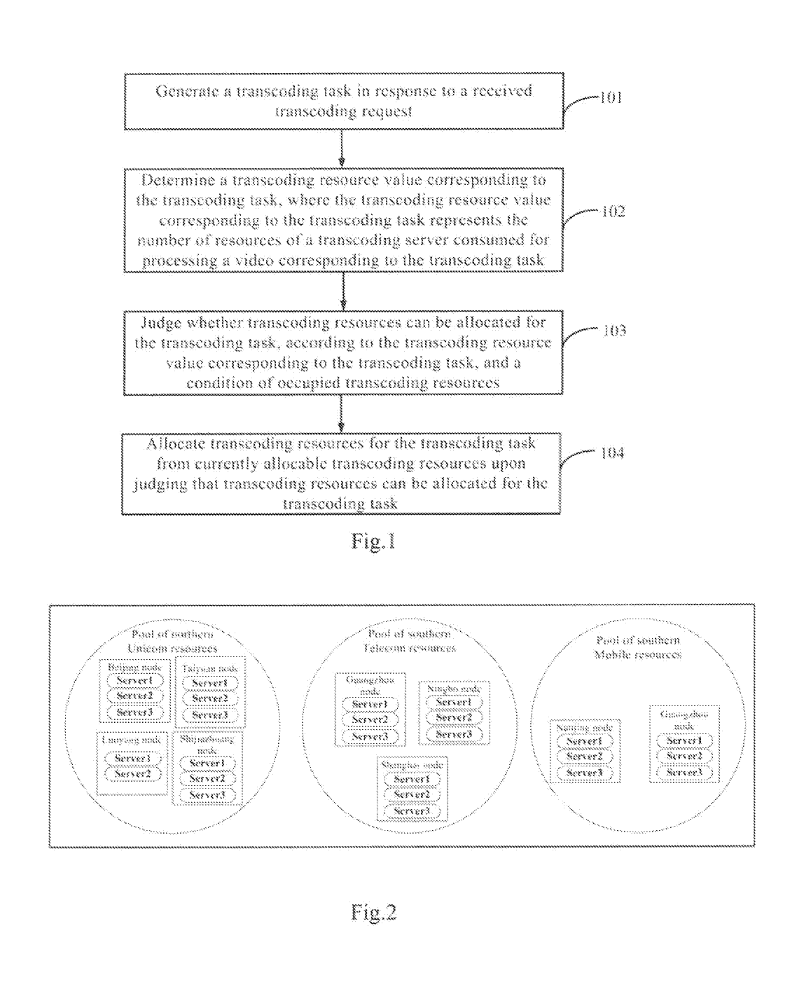

As illustrated in FIG. 2. in an embodiment of this disclosure, physical nodes can be grouped into respective pools of transcoding resources according to different regions where the physical nodes reside, different operators, different separate demands of users for resources, and other conditions, where each pool of transcoding resources includes at least one physical wide, each of which includes at least one transcoding server.

Since there may be a large number of transcoding tasks generated in a period of time in an implementation, at this time the transcoding tasks need to be put into a queue of resource requests, and the transcoding tasks in the queue of resource requests can be executed sequentially.

Optionally in an embodiment of this disclosure, each pool of transcoding resources corresponds to a pool of resource requests. Particularly after a transcoding task is generated in response to a received video transcoding request, a pool of transcoding resources corresponding to the transcoding task is determined, where the pool of transcoding resources includes a number of transcoding servers:

The transcoding task is put in a queue of resource request for the pool of transcoding resources corresponding to the transcoding task.

Optionally in an embodiment of this disclosure, a priority can be further preset for each transcoding task, so that the priority corresponding to the transcoding task is determined, and the transcoding task is put into a queue of resource requests for a pool of transcoding resources corresponding to the transcoding task according to the priority corresponding to the transcoding task.

For example, the transcoding tasks with higher priorities can be put before the transcoding tasks with lower priorities.

A priority corresponding to each transcoding task can be determined by determining the priority corresponding to the transcoding task according to the definition of the video to be transcoded, for example, there is a higher priority corresponding to a transcoding task at a higher definition; or the priority corresponding to the transcoding task can be adaptively calculated.

The priority corresponding to the transcoding task can be adaptively calculated particularly by calculating the priority of the video source according to the transcoding parameters, and the video source information, so that the different videos are prioritized. Further to the priorities of the video sources, the priorities can be adapted for the tasks at the different definitions (e.g., in an order of ascending priorities, based on the definitions), and resulting priorities are calculated for different demands for transcoding.

It shall be noted that the two approaches in which the priorities corresponding to the transcoding tasks are determined have been described merely as an example, but any other approach in which the priorities corresponding to the transcoding tasks can be determined will be applicable to the embodiment of this disclosure.

In an implementation, after the transcoding task is put into the queue of resource requests according to the pool of transcoding resources and the priority, it is judged whether transcoding resources in the pool of transcoding resources can be allocated for the transcoding task in the queue of resource requests.

Optionally the target transcoding task for which this judgment currently needs to be made is determined in an arrangement, order of the transcoding tasks in the queue of resource request; and

If one of die following conditions is satisfied, then it will be judged that transcoding resources can be allocated for the target transcoding task:

A first condition that there is such a transcoding server in the pool of transcoding resources that has an idle transcoding resource value above a preset threshold;

A second condition that there is such a transcoding server in the pool of transcoding resources that has an idle transcoding resource value more than the transcoding resource value corresponding to the target transcoding task;

A third condition that there is such a transcoding server in the pool of transcoding resources in which a sum of an idle transcoding resource value thereof and an available overload resource value is more than the transcoding resource value of the target transcoding task.

In an implementation, the judgment can be performed for next one of the transcoding tasks in the queue of transcoding resource requests, after one of the transcoding tasks in the queue of transcoding resource requests being completed, or while the transcoding task is being executed.

Optionally if it is judged that no transcoding resources can be allocated for the target transcoding task, then next one of the transcoding tasks in the queue of resource request can be determined as the target transcoding task.

A particular example will be given below in which the three conditions above are described in details.

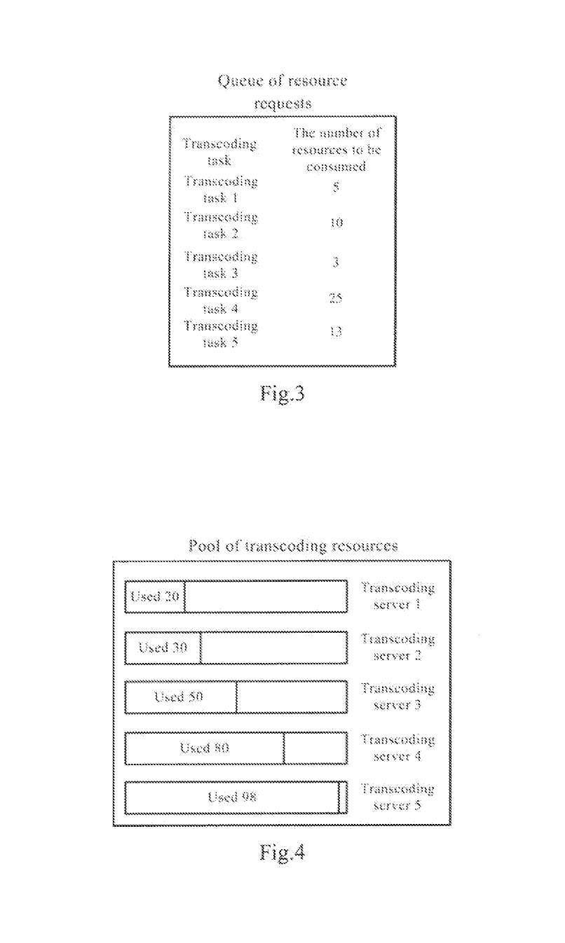

As illustrated in FIG. 3, if there are 5 transcoding tasks in a queue of resource requests corresponding to the current pool A of transcoding resources, then 5, 10, 3, 25, and 13 resources will be consumed respectively for the transcoding tasks.

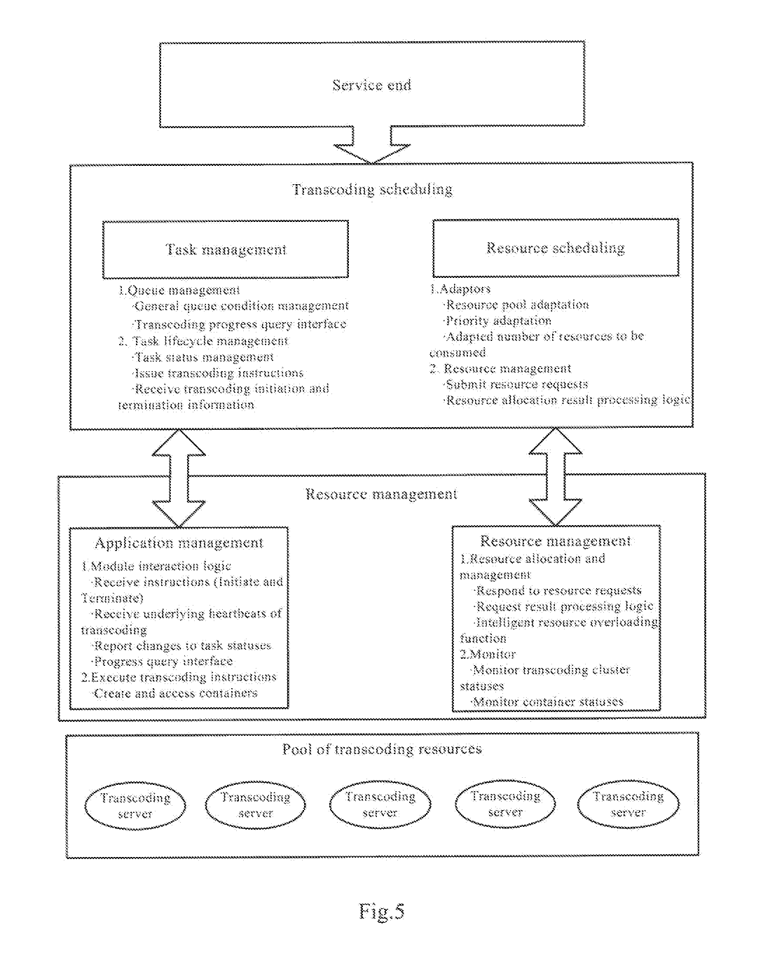

As illustrated in FIG. 4, if there are 5 transcoding servers in the current pool A of transcoding resources, then their idle transcoding resource values will be 80, 70, 50, 20 and 2 respectively.

Under the first condition, if the preset threshold is 50, then there will be two transcoding servers with more than 50 idle resources in FIG. 4, so resources can be allocated for the first transcoding task in the queue of resource requests in FIG. 3, where the resources are of one of the transcoding servers with the idle transcoding resource values of 80 and 70.

If the resources are of the transcoding server with the idle transcoding resource value of 80, then since the transcoding resource value of the first transcoding task is 5, the transcoding server with the idle transcoding resource value of 80 will be changed to 75.

Then the idle transcoding resource values are 75, 70,50, 20 and 2 respectively, and the judgment is further made for a next transcoding task.

Under die second condition, all the idle resource values of the transcoding servers 1, 2, 3 and 4 among all the transcoding servers in FIG. 4 are more than 5, and since the transcoding resource value of the first transcoding task is 5, resource can be allocated for the first transcoding task in the queue of resource requests in FIG. 3, where the resources are of any one of the transcoding servers 1, 2,3 and 4 in FIG. 4.

Since the transcoding resource value of the second transcoding task is 10, resource can be allocated for the second transcoding task.

Under the third condition, if all the idle transcoding resource values of the respective transcoding servers are 1, and an available overload resource value of each transcoding server is 3, then resources can be allocated only for the third transcoding task (i.e., the transcoding task with the consumption resource value of 3).

Optionally if it is judged that transcoding resources can be allocated for the target transcoding task, then transcoding will be performed over the resources corresponding to the target transcoding task; and if it is judged that no transcoding resources can be allocated for the target transcoding task, then the target transcoding task will be put into a queue of failing resource requests, and resources will be requested again for the respective transcoding tasks in the queue of failing resource requests in their arrangement order.

If the number of failures for a transcoding task reaches a preset threshold, or a user initiating the transcoding task stops transcoding, or another situation occurs that the transcoding task needs to be terminated, then the transcoding task will be deleted.

A transcoding execution instruction can be processed particularly as follows:

One of the transcoding servers capable of executing the target transcoding task is selected; and the selected transcoding server is notified of transcoding information corresponding to the target transcoding task.

In an implementation, the pool of transcoding resources for the transcoding task corresponding to the transcoding execution instruction, and the transcoding resources required for the transcoding task are determined; and the corresponding transcoding server is controlled according to the transcoding information corresponding to the transcoding task to transcode.

The transcoding information include but will not be limited to a part or ail of:

The video to be transcoded, the target transcoding format, and the resources required for transcoding.

A container is created in the transcoding server corresponding to the resources required for transcoding; and the transcoding server runs a corresponding application to transcode the video to be transcoded.

After transcoding is finished or cancelled, the transcoding server destroys the application and the container for transcoding, and releases the corresponding transcoding resources.

Optionally in order to detect a transcoding condition at any time, the transcoding server can report heartbeat data while transcoding;

A condition of the target transcoding task being executed can be determined from the heartbeat data upon reception of the heartbeat data.

Furthermore the heartbeat data can be further displayed by the service end to the user.

The heartbeat data in an embodiment of this disclosure includes the transcoding progress, an exported length of time for transcoding, and other information.

Instead of reporting by the transcoding server, a transcoding progress query interface can be provided in an embodiment of this disclosure so that the user can make a query about a progress of ongoing transcoding via the transcoding progress query interface.

In order to manage each video transcoding request, the video transcoding request can be further configured with a lifecycle.

The lifecycle corresponding to each video transcoding request is updated according to the current state of the video transcoding request, and applications, units, etc., which need to make a query are provided with an interface via which a query about the lifecycle of the video transcoding request is made.

For example, the lifecycle of the transcoding task can be updated after transcoding is finished or cancelled.

Optionally in an embodiment of this disclosure, the lifecycle of the video transcoding request can be a fixed status identifier, e.g.:

Status=0 indicates that the transcoding request is received;

Status=1 indicates that the task is generated;

Status=2 indicates that resources are requested successfully;

Status=3 indicates ongoing transcoding;

Status=10 indicates that transcoding is finished and a result is reported;

Status=10 indicates that transcoding fails.

It shall be noted that the form of the lifecycle and the contents thereof have been described above merely as an example, but any other information capable of indicating the state of the video transcoding request will be applicable to the embodiment of this disclosure.

As illustrated in FIG. 5, the method according to the embodiment of this disclosure generally includes the following four sections:

The first section relates to the service end similar to a client, where the user can initiate a video transcoding request at the service end.

The second section relates to transcoding scheduling.

Transcoding scheduling includes the following two parts:

The first part relates to task management:

1. This stage is responsible for managing the queues, particularly including managing the general condition of the queues, and the transcoding progress query interface;

2. This stage is responsible for lifecycle management, particularly including managing the states of tasks, issuing transcoding instructions, and receiving transcoding initiation and termination information.

The second part relates to resource Scheduling:

1. This stage is responsible for adaptation, particularly including adapting the pools of transcoding resources, adapting the priorities, and adapting the numbers of consumed resources;

2. This stage is responsible for managing the resources, particularly including submitting the resource requests, and responding to the resource allocation results.

The third section relates to resource management.

Resource management includes the following two parts:

The first pan relates to application management:

1. The first stage is responsible for interaction logics between the units, particularly including receiving instructions, receiving heartbeat data, reports changes to the states of the tasks, and the transcoding progress query interface; and

2. The second stage is responsible for executing the transcoding instructions, particularly including creating and accessing the containers.

The second part relates to resource management:

1. The first stage is responsible for resource allocation and management, particularly includes processing the resource requests, processing the request results, and allocating the resources; and

2. The second stage is responsible for monitoring, particularly including monitoring the states of the transcoding servers, and monitoring the states of the containers.

The fourth section relates to the pools of transcoding resources.

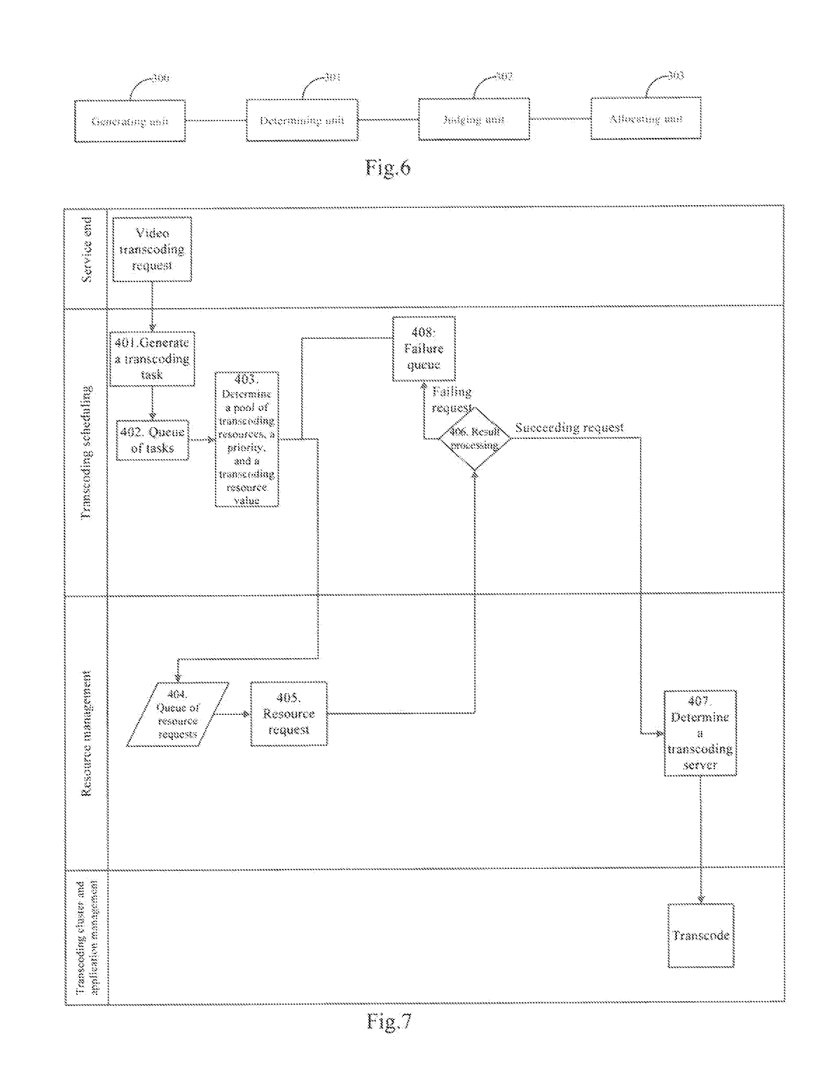

As illustrated in FIG. 6, an embodiment of this disclosure provides a system for allocating transcoding resources, which includes a generating unit 300, a determining unit 301, a judging unit 302, and an allocating unit 303.

Here the generating unit 300, the determining unit 301, the judging unit 302, and the allocating unit 303 in the embodiment of this disclosure can be embodied by a hardware processor. The respective units in the apparatus for allocating video transcoding resources in the embodiment of this disclosure can be integrated in a single entity, or can be distributed in more than one entity.

The generating unit 300 is configured to generate a transcoding task in response to a received transcoding request;

The determining unit 301 is configured to determine a transcoding resource value corresponding to the transcoding task, where the transcoding resource value corresponding to the transcoding task represents the number of resources of a transcoding server consumed for processing a video corresponding to the transcoding task;

The judging unit 302 is configured to judge whether transcoding resources can be allocated for the transcoding task, according to the transcoding resource value corresponding to the transcoding task, and a condition of occupied transcoding resources; and

The allocating unit 303 is configured to allocate transcoding resources for the transcoding task from currently allocable transcoding resources after the judging unit judges that transcoding resources can be allocated for the transcoding task.

In an embodiment of this disclosure, if there is a demand for transcoding the video, then a video transcoding request can be transmitted through a service end.

For example, if a user needs to transcode the video, then the user can transmit the video transcoding request through the service end.

Since there may be a large number of video transcoding requests received by the generating unit 300 in a period of time, optionally the generating unit 300 can put the video transcoding requests into a queue of tasks upon reception of the video transcoding requests, and then execute the tasks in the queue of tasks sequentially in their order in the queue of tasks.

The generating unit 300 can put the video transcoding requests into the queue of tasks in a number of ways, for example, the video transcoding requests can be put into the queue of tasks in an order of the times when the video transcoding requests are received; or the video transcoding requests can be put into the queue of tasks in an order of the priorities of the video transcoding requests.

If the video transcoding requests are put into the queue of tasks in an order of the times when the video transcoding requests are received, then a newly received video transcoding request can be put at the end of the queue of tasks upon reception of the new video transcoding request.

If the video transcoding requests are put into the queue of tasks in an order of the priorities of the video transcoding requests, then the video transcoding requests with higher priorities can be put before the video transcoding requests with lower priorities.

Optionally the priorities of the video transcoding requests can be preset, on demand, for example, the priorities of the video transcoding requests can be determined by video formats into which the video transcoding requests need lo be transcoded; or the priorities of the video transcoding requests can be determined by users transmitting the video transcoding requests.

In an embodiment of this disclosure, a transcoding resource consumption evaluating system is introduced. The transcoding resource consumption evaluating system in the embodiment of this disclosure includes the transcoding resource value corresponding to tire transcoding task, and the condition of occupied transcoding resources (the condition of occupied transcoding resource resources will be described later).

For the transcoding resource value corresponding to the transcoding task, the different transcoding tasks relate to different sizes and formats of video sources, and different target output definitions, so the transcoding tasks may consume significantly different transcoding resources.

In an embodiment of this disclosure, the transcoding server of which the elementary number of resources of the transcoding server is 100, acts to a carrier to estimate the numbers of resources to be consumed for the different transcoding tasks to thereby calculate the theoretical numbers of resources to be consumed for transcoding the videos into the respective levels of definitions.

Here the elementary number of resources is merely exemplified as 100, but can be another value as needed.

Optionally the transcoding resource value corresponding to the transcoding task can be determined by the determining unit 301 determining the transcoding resource value corresponding to the transcoding task according to a correspondence relationship between video formats and transcoding resource values.

The correspondence relationship between video formats and transcoding resource values can be present empirically on demand, etc.

In an embodiment of this disclosure, all the production data are collected and processed by a way of big data acquisition in a routine transcoding process, and after the data are obtained, real resource consumption values of transcoding tasks at respective levels of definitions are calculated from the data according to the distribution of the respective definitions in the real production data.

The determining unit 301 is configured:

To sample the transcoding server executing the transcoding task to obtain resource information of the transcoding server, and video format-speed ratio of the currently transcoding resources, where the video format-speed ratio refers to the ratio of the length of time taken to transcode into the video format to the length of time for the corresponding resource; to determine transcoding resource values of the different video formats according to the resource information of the transcoding server, and the video format-speed ratio of the currently transcoding resources, which are obtained as a result of sampling for a number of times; to determine the average transcoding resource value of the same video format by averaging transcoding resource values of the same video format; and to update the transcoding resource value corresponding to the video format in the correspondence relationship using the average transcoding resource value of the same video format.

Optionally the transcoding resource value of the video format is determined in the equation of:

A₁×C₁×R₁+A₂×C₂×R₂+. . . Aₙ×Cₙ×Rₙ=Y_{z}

Where Rn represents a transcoding resource value of a video format n; Aₙ represents a video format speed ratio of the video format n; Cₙ represents the number of parallel task of the transcoding server Z being sampled; and Y_{z}=*M_{z}*P_{z}, where Y_{z} represents the resource information of the transcoding server Z, M_{z} represents a resource score of the transcoding server Z, and P_{z} represents the occupancy ratio of resources of the transcoding server Z being sampled,

In an implementation, the video format speed ratio can be calculated by weight-averaging video format-speed ratio of a number of tasks as a stable value over a long period of time.

For example, if a transcoding task needs to convert a resource A into the mp4_640 format, a period of time taken to transcode the resource A into the mp4_640 format is determined as T1, and a length of time taken to play a section thereof to be transcoded is determined as T2 (for example, if contents of the resource A from die 60^{th} minute to the 120^{th} minute needs to be transcoded, then T1 will represent a period of time taken to transcode the contents of the resource A from the 60^{th} minute to the 120^{th} minute, and T2 will represent a length of time taken to play the section to be transcoded, i.e., a length of lime from the 60^{th} minute to the 120^{th} minute, which is 60 minutes here), then T2/T1 will be calculated as a video format speed ratio of the mp4_640 format, and a number of video format-speed ratio of die mp4_640 format will be weight-averaged as a resulting video format speed ratio of the mp4_640 format.

Subsequently calculated new video format-speed ratio of the mp4_640 format are constantly added to and weight-summed with the last resulting video format-speed ratio, thus resulting in a stable value over a long period of time.

The resource score of the transcoding server Z is a reference score calculated by testing periodically the performance of a machine.

Here taking a month (or a season or a year or more) of data as a unit of time, for example, the theoretical estimated values in the table above can be revised using the real resource consumption values, where the theoretical estimated values are revised constantly by constantly generating a large number of data samples throughout transcoding, and calculating their weight-averages, so that the theoretical values unlimitedly approximate the real consumption values.

It shall be noted that the embodiment of this disclosure will not be limited to the approach above in which the transcoding resource value corresponding to the transcoding task is determined, but any other approaches in which the transcoding resource value corresponding to the transcoding task is determined will be applicable to the embodiment of this disclosure.

In the embodiment of this disclosure, the video is transcoded by the transcoding server, and since there are a large number of widely distributed transcoding servers, the transcoding servers are grouped into a number of pools of transcoding servers in art embodiment of this disclosure to thereby manage and search for the transcoding resources conveniently.

As illustrated in FIG. 2, in an embodiment of this disclosure, physical nodes can be grouped into respective pools of transcoding resources according to different regions where the physical nodes reside, different operators, different separate demands of users for resources, and other conditions, where each pool of transcoding resources includes at least one physical node, each of which includes at least one transcoding server.

Since there may be a large number of transcoding tasks generated in a period of time in an implementation, at this time the transcoding unit 301 needs to put the transcoding tasks into a queue of resource requests.

Optionally in an embodiment of this disclosure, each pool of transcoding resources corresponds to a pool of resource requests. Particularly the transcoding unit 301 is further configured:

After the transcoding task is generated by the generating unit in response to the received video transcoding request, to determine a pool of transcoding resources corresponding to the transcoding task, where the pool of transcoding resources includes a number of transcoding servers; and to allocate resources for the transcoding task from the pool of transcoding resources corresponding to the transcoding task.

Optionally the transcoding unit 301 is further configured:

After the transcoding task is generated by the generating unit, to determine a priority corresponding to the transcoding task, and to put the transcoding task into a queue of resource requests according to the priority corresponding to the transcoding task.

Optionally the judging unit 302 is configured:

To determine the target transcoding task for which this judgment currently needs to be made, in an arrangement order of the transcoding tasks in the queue of resource request;

If one of the following conditions is satisfied, to judge that transcoding resources can be allocated tor the target transcoding task:

A first condition that there is such a transcoding server in the pool of transcoding resources that has an idle transcoding resource value above a preset threshold;

A second condition that there is such a transcoding server in the pool of transcoding resources that has an idle transcoding resource value more than the transcoding resource value corresponding to the target transcoding task; and

A third condition that there is such a transcoding server in the pool of transcoding resources in which a sure of an idle transcoding resource value thereof and an available overload resource value is more than the transcoding resource value of the target transcoding task.

In an implementation, the judgment can be performed for next one of the transcoding tasks, after the judgment is made for one of the transcoding tasks in the queue of transcoding resource requests, or while the transcoding task is being executed.

Optionally if it is determined that no transcoding resources can be allocated for the target transcoding task, then the judging unit 302 will determine next one of the transcoding tasks in the queue of resource requests as the target transcoding task.

Optionally the judging unit 302 is further configured;

After it is judged whether transcoding resources can be allocated for the transcoding task in the queue of resource requests, if it is determined that no transcoding resources can be allocated for the target transcoding task, to determine next one of the transcoding tasks in the queue of resource requests as the target transcoding task.

If it is determined that transcoding resources can be allocated for the target transcoding task, then the judging unit 302 can perform transcoding over the resources corresponding to the target transcoding task: and if it is determined that no transcoding resources can be allocated for the target transcoding task, then the judging unit 302 can the target transcoding task a queue of failing resource requests, and request for resources again for the respective transcoding tasks in the queue of failing resource requests in their arrangement order.

If the number of failures for a transcoding task reaches a preset threshold, or a user initiating the transcoding task stops transcoding, or another situation occurs that the transcoding task needs to be terminated, then the allocating unit 303 will delete the transcoding task.

Optionally the allocating unit 303 is configured:

To select one of transcoding servers capable of executing the target transcoding task; and to notify the selected transcoding server of transcoding information corresponding to the target transcoding task so that the transcoding server executes the target transcoding task.

In an implementation, the allocating unit 303 selects one of transcoding servers capable of executing the target transcoding task; and notifies the selected transcoding server of transcoding information corresponding to the target transcoding task.

The allocating unit 303 determines the pool of transcoding resources of the transcoding task, and the transcoding resources required (or the transcoding task; and controls the corresponding transcoding server according to the transcoding information corresponding to the transcoding task to transcode.

Tire transcoding information include but will not be limited to a part or all of:

The video to be transcoded, the target transcoding format, and the resources required for transcoding.

The allocating unit 303 creates a container in the transcoding server according to the resources required for transcoding; and the transcoding server runs a corresponding application to transcode the video to be transcoded.

After transcoding is finished or cancelled, the transcoding server destroys the application and the container tor transcoding, and releases the corresponding transcoding resources.

Some embodiments of this disclosure further provide a system for allocating transcoding resources. The system comprises at least one processor and a memory communicably connected with the at least one processor tor storing instructions executable by the at least one processor, wherein execution of the instructions by the at least one processor causes the at least one processor to;

generate a transcoding task in response to a received transcoding request;

determine a transcoding resource value corresponding to the transcoding task, wherein the transcoding resource value corresponding to the transcoding task represents the number of resources of a transcoding server consumed for processing a video corresponding to the transcoding task;

judge whether transcoding resources can be allocated for the transcoding task, according to the transcoding resource value corresponding to the transcoding task, and a condition of occupied transcoding resources;

allocate transcoding resources for the transcoding task from currently allocable transcoding resources after the judging unit judges drat transcoding resources can be allocated for the transcoding task.

The determine the transcoding resource value corresponding to the transcoding task comprises:

determine the transcoding resource value corresponding to the transcoding task according to a correspondence relationship between video formats and transcoding resource values.

The determine the transcoding resource value corresponding to the transcoding task further comprises:

sample die transcoding server executing the transcoding task to obtain resource information of the transcoding server, and video format-speed ratio of currently transcoding resources, wherein the video format speed ratio refers to a ratio of a length of time taken to transcode into the video format to a length of time for a corresponding resource;

determine transcoding resource values of the different video formats according to the resource information of the transcoding server, and the video format-speed ratio of the currently transcoding resources, which are obtained as a result of sampling for a number of times;

determine an average transcoding resource value of the same video format by averaging transcoding resource values of the same video format; and

update the transcoding resource value corresponding to the video format in the correspondence relationship using the average transcoding resource value of the same video format.

The transcoding resource value of the video format is determined in an equation of:

A₁×C₁×R₁+A₂×C₂×R₂+ . . . Aₙ×Cₙ×Rₙ=Y_{z}

wherein Rn represents a transcoding resource value of a video format n; Aₙ represents a video format speed ratio of the video format n; Cₙ represents die number of parallel tasks of a transcoding server Z being sampled; and Y_{z}=M_{z}*P_{z}, wherein Y_{z} represents the resource information of the transcoding server Z, M_{z} represents a resource score of the transcoding server Z, and P_{z} represents an occupancy ratio of resources of the transcoding server Z being sampled.

The judge whether transcoding resources can be allocated for the transcoding task further comprises:

if one of following conditions is satisfied, to judge that transcoding resources can be allocated for the target transcoding task;

a first condition that there is such a transcoding server that has an idle transcoding resource value above a preset threshold;

a second condition that there is such a transcoding server that has an idle transcoding resource value more than the transcoding resource value corresponding to the transcoding task;

a third condition that there is such a transcoding server in which a sum of an idle transcoding resource value thereof and a specific resource value is more than the transcoding resource value of the transcoding task, wherein the specific resource value is a resource value occupied for the transcoding task transcoding on the transcoding server and capable of being finished in a preset length of lime.

An example of transcoding a video according to an embodiment of this disclosure will be fully given below.

As illustrated in FIG. 7, a method for transcoding a video according to an embodiment of this disclosure includes:

The step 401 is to generate a transcoding task in response to a video transcoding request transmitted by a user to a server upon reception of the video transcoding request.

The step 402 is to put the generated transcoding task into a queue of tasks.

The step 403 is to pick out the very beginning transcoding task in the queue of tasks, and to determine a pool of transcoding resources, a priority, and a transcoding resource value corresponding to the transcoding task.

The step 404 is to determine the pool of transcoding resources corresponding to the transcoding task according to the determined pool of transcoding resources, and to put the transcoding task into a queue of resource requests corresponding to the pool of transcoding resources according to the determined priority.

The step 405 is to pick up for a queue of resource requests corresponding to a pool of transcoding resources the very beginning transcoding task in the queue of resource requests, to judge whether transcoding resources can be allocated for the transcoding task, according to the transcoding resource value corresponding to the transcoding task, and a condition of occupied transcoding resources, and to return a judgment result to a transcoding scheduling center.

The step 406 is to proceed to the step 407 if it is judged from the received judgment result that transcoding resources can be allocated for the transcoding task; and to proceed to the step 408 if it judged from the received judgment result that transcoding resources cannot be allocated for the transcoding task.

The step 407 is to determine a transcoding server according to corresponding transcoding information of the transcoding task, and to create a container in the transcoding server so that the transcoding server runs a corresponding application to transcode.

The step 408 is to put the transcoding task for which resources fail to be allocated, into a failure queue, and to request resources asynchronously for the transcoding task.

in an implementation, resources can be requested asynchronously by launching a timed asynchronous scanning task for timed catching of tasks in the failure queue (for example. 10 failing tasks are scanned and caught every free seconds), and requesting resources again for the caught failing tasks.

As can be apparent from the disclosure above, in the embodiments of this disclosure, a resource value to be consumed for transcoding a video corresponding to a transcoding task is determined; and transcoding resources are allocated for the transcoding task from currently allocable transcoding resources upon judging that, transcoding resources can be allocated for the transcoding task, according to the transcoding resource value corresponding to the transcoding task, and a condition of occupied transcoding resources, instead of configuring a fixed workload of transcoding as in the prior art, thus improving the utilization ratio of the resources so that if there are a number of videos to be transcoded, then the efficiency of transcoding will be improved.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the invention; and although the invention has been described above in details with reference to the embodiments above, those ordinarily skilled in the art shall appreciate that they can modify tire technical solution recited in the respective embodiments above or make equivalent substitutions to a part of the technical features thereof; and these modifications or substitutions to the corresponding technical solution shall also fall into the scope of the invention as claimed.

1. A method for allocating video transcoding resources, comprising:
generating a transcoding task in response to a received transcoding request;
determining a transcoding resource value corresponding to the transcoding task, wherein the transcoding resource value corresponding to the transcoding task represents the number of resources of a transcoding server, consumed for processing a video corresponding to the transcoding task;
judging whether transcoding resources can be allocated for the transcoding task, according to the transcoding resource value corresponding to the transcoding task, and a condition of occupied transcoding resources;
allocating transcoding resources for the transcoding task from currently allocable transcoding resources upon judging that transcoding resources can be allocated for the transcoding task.

2. The method according to claim 1, wherein the determining the transcoding resource value corresponding to the transcoding task comprises:
determining the transcoding resource value corresponding to the transcoding task according to a correspondence relationship between video formats and transcoding resource values.

3. The method according to claim 2, wherein the method further comprises:
sampling the transcoding server executing the transcoding task to obtain resource information of the transcoding server, and video format-speed ratio of currently transcoding resources, wherein the video format-speed ratio refers to a ratio of a length of time taken to transcode into the video format, to a length of time for a corresponding resource;
determining transcoding resource values of the different video formats according to the resource information of the transcoding server, and the video format-speed ratio of the currently transcoding resources, which are obtained as a result of sampling for a number of times;
determining an average transcoding resource value of the same video format by averaging transcoding resource values of the same video format;
updating the transcoding resource value corresponding to the video format in the correspondence relationship using the average transcoding resource value of the same video format.

4. The method according to claim 3, wherein the transcoding resource value of the video formal is determined in an equation of:
A₁×C₁×R₁+A₂×C₂×R₂+ . . . Aₙ×Cₙ×Rₙ=Y_{z}
wherein Rn represents a transcoding resource value of a video formal n; Aₙ represents a video format speed ratio of the video format n; Cₙ represents the number of parallel tasks of a transcoding server Z being sampled; and Y_{z}=M_{z}*P_{z}, wherein Y_{z} represents the resource information of the transcoding server Z, M_{z} represents a resource score of the transcoding server Z, and P_{z} represents an occupancy ratio of resources of the transcoding server Z being sampled.

5. The method according to claim 1, wherein the judging whether transcoding resources can be allocated for the transcoding task comprises:
if one of following conditions is satisfied, then judging that transcoding resources can be allocated for the target transcoding task:
a first condition that there is such a transcoding server that has an idle transcoding resource value above a preset threshold;
a second condition that there is such a transcoding server that has an idle transcoding resource value more than the transcoding resource value corresponding to the transcoding task; and
a third condition that there is such a transcoding server in which a sum of an idle transcoding resource value thereof and a specific resource value is more than the transcoding resource value of the transcoding task, wherein the specific resource value is a resource value occupied for the transcoding task transcoding on tire transcoding server and capable of being finished in a preset length of time.

6. The method according to claim 2, wherein the judging whether transcoding resources can be allocated for the transcoding task comprises:
if one of following conditions is satisfied, then judging that transcoding resources can be allocated for the target transcoding task:
a first condition that there is such a transcoding server that has an idle transcoding resource value above a preset threshold;
a second condition that there is such a transcoding server that has an idle transcoding resource value more than the transcoding resource value corresponding to the transcoding task; and
a third condition that there is such a transcoding server in which a sum of an idle transcoding resource value thereof and a specific resource value is more than the transcoding resource value of the transcoding task, wherein the specific resource value is a resource value occupied for the transcoding task transcoding on the transcoding server and capable of being finished in a preset length of time.

7. The method according to claim 3, wherein the judging whether transcoding resources can be allocated for the transcoding task comprises:
if one of following conditions is satisfied, then judging that transcoding resources can be allocated for the target transcoding task;
a first condition that there is such a transcoding server that has an idle transcoding resource value above a preset threshold;
a second condition that there is such a transcoding server that has an idle transcoding resource value more than the transcoding resource value corresponding to the transcoding task; and
a third condition that there is such a transcoding server in which a sum of an idle transcoding resource value thereof and a specific resource value is more than the transcoding resource value of the transcoding task, wherein the specific resource value is a resource value occupied for the transcoding task transcoding on the transcoding, server and capable of being finished in a preset length of time.

8. The method according to claim 4, wherein the judging whether transcoding resources can be allocated for the transcoding task comprises:
if one of following conditions is satisfied, then judging that transcoding resources can be allocated for the target transcoding task:
a first condition that there is such a transcoding server that has an idle transcoding resource value above a preset, threshold;
a second condition that there is such a transcoding server that has an idle transcoding resource value more than the transcoding resource value corresponding to the transcoding task; and
a third condition that there is such a transcoding server in which a sum of an idle transcoding resource value thereof and a specific resource value is more than the transcoding resource value of the transcoding task, wherein the specific resource value is a resource value occupied for the transcoding task transcoding on the transcoding server and capable of being finished in a preset length of time.

9. A system for allocating transcoding resources, comprising:
at least one processor; and
a memory communicably connected with the at least one processor for storing instructions executable by the at least one processor, wherein execution of the instructions by the at least one processor causes the at least one processor to:
generate a transcoding task in response to a received transcoding request;
determine a transcoding resource value corresponding to the transcoding task, wherein the transcoding resource value corresponding to the transcoding task represents the number of resources of a transcoding server consumed for processing a video corresponding to the transcoding task;
judge whether transcoding resources can be allocated for the transcoding task, according to the transcoding resource value corresponding to the transcoding task, and a condition of occupied transcoding resources;
allocate transcoding resources for the transcoding task from currently allocable transcoding resources after the judging unit judges that transcoding resources can be allocated for the transcoding task.

10. The system according to claim 9, wherein the determine the transcoding resource value corresponding to the transcoding task comprises:
determine the transcoding resource value corresponding to the transcoding task according to a correspondence relationship between video formats and transcoding resource values.

11. The system according to claim 10, wherein the determine the transcoding resource value corresponding to the transcoding task further comprises:
sample the transcoding server executing the transcoding task to obtain resource information of the transcoding server, and video format-speed ratio of currently transcoding resources, wherein the video format-speed ratio refers to a ratio of a length of time taken to transcode into the video format to a length of time for a corresponding resource;
determine transcoding resource values of the different video formats according to the resource information of the transcoding server, and the video format-speed ratio of the currently transcoding resources, which are obtained, as a result of sampling for a number of times;
determine an average transcoding resource value of the same video format by averaging transcoding resource values of the same video format; and
update the transcoding resource value corresponding to the video format in the correspondence relationship using the average transcoding resource value of the same video format.

12. The system according to claim 11, wherein the transcoding resource value of the video format is determined in an equation of;
A₁×C₁×R₁+A₂×C₂×R₂+ . . . Aₙ×Cₙ×Rₙ=Y_{z}
wherein Rn represents a transcoding resource value of a video format n; Aₙ represents a video format speed ratio of the video format n; Cₙ represents the number of parallel tasks of a transcoding server Z being sampled; and Y_{z}=M_{z}*P_{z}, wherein Y_{z} represents, the resource information of the transcoding server Z, M_{z} represents a resource score of the transcoding server Z, and P_{z} represents an occupancy ratio of resources of the transcoding server Z being sampled.

13. The system according to claim 9, wherein the judge whether transcoding resources can be allocated for the transcoding task further comprises;
if one of following conditions is satisfied, to judge that transcoding resources can be allocated for the target transcoding task:
a first condition that there is such a transcoding server that has an idle transcoding resource value above a preset threshold;
a second condition that there is such a transcoding server that has an idle transcoding resource value more than the transcoding resource value corresponding to the transcoding task; and
a third, condition that there is such a transcoding server in which a sum of an idle transcoding resource value thereof and a specific resource value is more than the transcoding resource value of the transcoding task, wherein the specific resource value is a resource value occupied for the transcoding task transcoding on the transcoding server and capable of being finished in a preset length of time.

14. The system according to claim 19, wherein the judge whether transcoding resources can be allocated for the transcoding task further comprises:
if one of following conditions, is satisfied, to judge that transcoding resources can be allocated for the target transcoding task:
a first condition that there is such a transcoding server that has an idle transcoding resource value above a present threshold;
a second condition that there is such a transcoding server that has an idle transcoding resource value more than the transcoding resource value corresponding to the transcoding task; and
a third condition that there is such a transcoding server in which a sum of an idle transcoding resource value thereof and a specific resource value is more than the transcoding resource value of the transcoding task, wherein the specific resource value is a resource value occupied for the transcoding task transcoding on the transcoding server and capable of being finished in a preset length of time.

15. The system according to claim 11, wherein the judge whether transcoding resources can be allocated for the transcoding task further comprises:
if one of follow trig conditions is satisfied, to judge that transcoding resources can be allocated for the target transcoding task:
a first condition that there is such a transcoding server that has an idle transcoding resource value above a preset threshold;
a second condition that there is such a transcoding server that has an idle transcoding resource value more than the transcoding resource value corresponding to the transcoding task; and
a third condition that there is such a transcoding server in which a sum of an idle transcoding resource value thereof and a specific resource value is more than the transcoding resource value of the transcoding task, wherein the specific resource value is a resource value occupied for the transcoding task transcoding on the transcoding server and capable of being finished in a preset length of time.

16. The system according to claim 12, wherein the judge whether transcoding resources can be allocated for the transcoding task further comprises:
if one of following conditions is satisfied, to judge that transcoding resources can be allocated for the target transcoding task:
a first condition that there is such a transcoding server that has an idle transcoding resource value above a preset threshold;
a second condition that there is such a transcoding server that has an idle transcoding resource value more than the transcoding resource value corresponding to the transcoding task; and
a third condition that there is such a transcoding server in which a sum of an idle transcoding resource value thereof and a specific resource value is more than the transcoding resource value of the transcoding task, wherein the specific resource value is a resource value occupied for the transcoding task transcoding on the transcoding server and capable of being finished in a preset length of time.
